(19) United States
(12) Patent Application Publication
(10) Pub. No.: US 2024/0389709 A1
(43) Pub. Date: Nov. 28, 2024

(54) SHOE SOLE

(71) Applicants: HAYDALE GRAPHENE INDUSTRIES PLC, Ammanford, South Wales (GB); HAYDALE COMPOSITES SOLUTIONS LTD, Loughborough, Leicestershire (GB)

(72) Inventors: John-Mark Seymour, Ammanford (GB); Thomas Greaves, Loughborough (GB); Matthew Thornton, Loughborough (GB)

(21) Appl. No.: 18/687,235

(22) PCT Filed: Sep. 1, 2022
(86) PCT No.: PCT/EP2022/074389

§ 371 Date: Feb. 27, 2024

(30) Foreign Application Priority Data
Sep. 1, 2021 (GB) 2112481.3

(51) Int. Cl. A43B 13/04; A43B 13/02; A43B 13/22; C08K 3/04; C08K 3/36; C08K 9/04

(52) U.S. Cl. CPC A43B 13/04; A43B 13/026; A43B 13/22; C08K 3/041; C08K 3/042; C08K 3/36; C08K 9/04

(57) ABSTRACT

The present invention relates to a shoe sole comprising a rubber matrix material comprising a butadiene rubber; and carbon nanoparticles comprising functionalised carbon nanoparticles, wherein, the carbon nanoparticles consist of graphene particles and/or carbon nanotubes. The present invention also relates to a method of manufacturing the shoe sole.

### FIELD OF THE INVENTION

The present invention relates to shoe soles, in particular to shoe soles for use in performance footwear.

### BACKGROUND OF THE INVENTION

Performance footwear refers to shoes that are purposefully optimised to provide the best performance for a specific activity, usually an activity where it is important that the shoes have good grip. Examples of such activities include mountaineering, hiking, trail running, road running, climbing or walking.

The primary characteristics of performance footwear are dictated by the nature of the shoe's sole. These soles can be made of a variety of materials such as natural materials for example leather as well as natural and synthetic resins having an elastomeric character. Generally, shoe soles developed for performance applications are made from natural or synthetic resins.

Shoe soles are required to have a range of functional properties, for example, it is desirable that shoe soles have good durability and wear resistance. Generally, the sole of a shoe is subjected to severe static deformation during use, e.g. compression, stretching and friction with the ground surface, which is why wear resistance or abrasion resistance is an important parameter that can characterise the longevity and durability of the shoe. Wear on shoe soles is a complex phenomenon, which is determined by various factors comprising short term events such as cutting of the surface of the sole, and events that develop over a longer period of time, such as the removal of material due to rubbing or scraping of the lower surface of the sole. The extent of this attrition will often be greater for softer materials, due to the greater surface area in contact with the ground.

It is also important that shoe soles are able to effectively grip the ground, particularly in wet or icy conditions. Generally, shoe soles with a good grip are made from a relatively soft compound, which adheres better to the ground or walking surface (for example by penetrating into the surface of the ground or walking surface), at the expense of wear resistance which is typically minimised with softer compounds.

Shoe soles are also required to display a range of other properties, for example shoe soles should be able to cushion the feet of a user, whilst also displaying high flexibility and stability. It is furthermore desirable to keep the weight of shoe soles to a minimum, particularly for applications such as road and trail running, and climbing.

It remains challenging to obtain a shoe sole that has both good grip and also high resistance to wear and abrasion. This is because the properties of grip and abrasion resistance generally require materials with opposing properties (e.g. hard and soft compounds).

There remains a need to develop shoe soles which are able to provide a good grip, display good wear resistance and which are also lightweight.

### SUMMARY OF THE INVENTION

The present inventors have developed a shoe sole which helps to address the practical problems outlined above.

Broadly, the present inventors have discovered that functionalised carbon nanoparticles can be efficiently used as a filler component in a shoe sole made (at least in part) from butadiene rubber to enhance the grip, structural and chemical properties and resistance to abrasion of the shoe sole.

Accordingly, in a first aspect the present invention provides a shoe sole comprising:
a rubber matrix material comprising a butadiene rubber; and
carbon nanoparticles comprising functionalised carbon nanoparticles,
wherein, the carbon nanoparticles consist of graphene particles and/or carbon nanotubes (CNTs).

Preferably, wherein the functionalised carbon nanoparticles are dispersed in the butadiene rubber.

Shoe soles comprising an elastomer and a graphene-based material are known from WO2019102194A1 and WO2020011511A1. WO2019102194A1 relates to shoe soles comprising polyurethane, ethylene-vinyl acetate, polyisoprene and natural rubber. However, the shoe soles described in WO2019102194A1 do not contain butadiene rubber. WO2020011511A1 relates to shoe soles comprising isoprene and polybutadiene. However, WO2020011511A1 does not provide any indication to use a functionalised carbon material.

In a second aspect, the present invention provides a shoe comprising the sole according to the first aspect.

The shoe soles according to the present invention have a number of advantageous features.

Firstly, the shoe soles demonstrate an excellent balance between grip and abrasion resistance on both wet and dry ground. These properties are improved compared to butadiene rubber alone. The butadiene rubber itself is a relatively soft compound, which is able to conform to different surfaces underfoot. It is believed that the addition of functionalised carbon nanoparticles helps to enhance the abrasion resistance of the butadiene rubber through bonding interactions between the carbon nanoparticles and the butadiene rubber matrix. This leads to a shoe sole that has a high coefficient of friction and consequently a high slip resistance, whilst at the same time also being resistant to abrasion.

Secondly, the presence of the carbon nanoparticles helps to reinforce the sole so as to improve mechanical properties, as well as improving thermal dissipation properties and barrier properties.

Thirdly, the carbon nanoparticles can be well-dispersed in the matrix with limited or no aggregation or “clumps”—in other words, with homogeneous distribution. This is because the functionalisation of the graphene particles and/or carbon nanotubes enhances dispersibility in the butadiene matrix material during manufacture. This means that the properties such as grip, wear resistance and structural properties are homogeneous over the entire sole. This can mean that the overall grip of the shoe sole is improved.

Fourthly, the inventors find that the functionalisation of the carbon nanoparticles can lead to improved interactions between the carbon nanoparticles and the matrix material, as compared to the interactions between non-functionalised carbon nanoparticles and the matrix material. This leads to enhanced reinforcement of the matrix material and enables force to be easily transferred from the carbon nanoparticles to the matrix material leading to improved mechanical characteristics such as higher tear strength, resistance to abrasion, slip resistance tensile strength, tensile modulus, elongation, ozone resistance (discussed further below), puncture resistance, wet grip, and rolling performance. This also helps to assist with the cushioning properties of the shoe soles.

Fifthly, the shoe sole can be made relatively lighter and thinner than conventional butadiene soles, since functionalisation allows higher levels of functionalised graphene particles and/or carbon nanotubes to be incorporated into the matrix material. It can also minimise or reduce the loading of other fillers such as carbon black and silica. In addition, the shoe sole can enhance grip as the concentration of functionalised filler in the butadiene matrix can be higher than that achieved in other shoe soles.

Sixthly, the shoe soles can have enhanced electrical conductivity, or minimal electrical resistivity, at very low filler loadings. This is because carbon nanotubes and graphene particles have high aspect ratios, which allow the formation of conductive paths at relatively low loading levels. This means that the shoe soles can be engineered to have anti-static properties. For antistatic properties shoe soles should generally have resistance values of around 1×10⁶Ω, these values can be achieved even when low loading levels of carbon nanoparticles are used.

Seventhly, the inventors have found that in some embodiments it is possible to improve the chemical resistance of the shoe sole to ozone (O₃) and related compounds. In particular, and without wishing to be bound by theory, the inventors find that their functionalisation process, which provides improved dispersion and distribution of the functionalised carbon nanoparticles within the matrix material, as well as enhancing interactions to deliver reinforcement and improved performance, enables the formation of a highly ordered and structured network through which ozone cannot, or has limited ability to, penetrate. In this way, chemical reactions—such as oxidation reactions—which might otherwise occur during use of a shoe sole—for example when it is stretched—are limited, inhibited, or prevented.

Without wanting to be bound by any theory, it is believed that having good ozone protection may be linked to a product with a longer shelf-life and which demonstrates less cracking over time.

In a further aspect, the present invention provides a composition comprising:
a butadiene rubber;
carbon nanoparticles comprising functionalised carbon nanoparticles; and
a plasticiser
   wherein, the carbon nanoparticles are graphene particles and/or carbon nanotubes.

In a further aspect, the present invention provides a composition and method of preparing the composition, the composition comprising:
a rubber;
carbon nanoparticles comprising functionalised carbon nanoparticles dispersed in the rubber; and
a plasticiser
   wherein, the carbon nanoparticles are or comprise graphene particles and/or carbon nanotubes.

These proposals also encompass an article comprising the composition according to the aspect described above.

Without wanting to be bound by any theory, it is firstly believed that articles made from the composition described above show improved grip and abrasion resistance.

Secondly, the use of a plasticiser simplifies manufacture of these compositions, because the butadiene rubber and carbon nanoparticles can be mixed more easily.

Thirdly, the plasticiser helps to improve the dispersion and distribution of the carbon nanomaterials during processing, which leads to enhanced performance of these materials.

Fourthly, the plasticiser makes the rubber matrix material softer, which leads to enhanced grip properties.

In a further aspect, the present invention provides a method of manufacture of a composition according to the present invention or a shoe sole composition suitable for use in the production of a shoe sole according to the present invention.

Also provided are a composition suitable for a shoe sole, uses of a composition described herein or as produced by the method as described herein, for a shoe sole, as well as use of plasma functionalised carbon nanoparticles as described herein in a shoe sole.

### DETAILED DESCRIPTION AND PREFERRED EMBODIMENTS

The present invention will now be described in detail with reference to preferred embodiments and other optional features.

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below. Unless clearly indicated otherwise, use of the terms “a,” “an,” and the like refers to one or more.

While the invention is described in conjunction with the exemplary embodiments described below, many equivalent modifications and variations will be apparent to those skilled in the art when given this disclosure. Accordingly, the exemplary embodiments set forth herein are considered to be illustrative and not limiting. Various changes may be made without departing from the scope of the invention which is defined by the claims. All references referred to herein are hereby incorporated by reference.

Each and every compatible combination of the embodiments described herein is explicitly disclosed herein, as if each and every combination was individually and explicitly recited. Additionally, where used herein, “and/or” is to be taken as a specific disclosure of each of the two specified features with or without the other.

Unless context dictated otherwise, the descriptions and definitions of the features set out herein are not limited to any particular aspect or embodiment and apply equally to all aspects and embodiments which are described where appropriate.

Where values are described as “at most” or “at least” it is understood that any of these values can be independently combined to produce a range.

Unless indicated otherwise, values provided are generally recorded at room temperature, that is, within the range 20-30° C. for example 20° C.

Where non-SI units are provided, it will be understood that these can be converted easily into SI units by the skilled person.

The use of headings herein is intended to be to assist the understanding of the invention by the reader and does not imply any limitation on the invention as defined in the claims.

### Rubber Matrix Material

The shoe soles according to the present invention comprise a rubber matrix material comprising a butadiene rubber.

Within the meaning of this invention, butadiene rubbers include butadiene rubber (BR, e.g. high cis polybutadiene, low cis polybutadiene, high vinyl polybutadiene, high trans polybutadiene), styrene butadiene rubber (SBR) and nitrile butadiene rubber (NBR). Butadiene rubbers are synthetic rubbers, these materials generally show improved abrasion resistance compared to natural rubbers and also demonstrate good heat resistance and heat aging qualities. The shoe soles of the present invention may include one or more butadiene rubbers, optionally in combination with other rubbers.

Preferably, the rubber matrix material has a density of from 50 to 120 kg m⁻³, more preferably from 60 to 110 kg m⁻³, more preferably from 70 to 100 kg m⁻³, most preferably from 85 to 100 kg m⁻³.

Generally, the matrix material does not comprise foamed butadiene rubber. Foamed butadiene rubber is butadiene rubber which has utilised a foaming agent, has been whipped or is processed by dissolving nitrogen gas into a polymer at extreme pressures and temperatures in order to create an air-filled matrix structure within the rubber. Foamed butadiene rubber generally has a much lower density than non-foamed butadiene rubber, generally foamed butadiene rubber has a density of less than 40 kg m⁻³. Without wanting to be bound by any theory, it is believed that foamed butadiene rubber shows inferior abrasion resistance compared to non-foamed butadiene rubber; therefore, the butadiene rubber according to the present invention is generally non-foamed butadiene rubber.

Preferably the rubber matrix material comprises from 20 to 99.5 wt. % of the weight of the shoe sole, preferably 30 to 99.5 wt. %, more preferably 30 to 80 wt. %, more preferably from 40 to 80 wt. %, more preferably from 50 to 80 wt. %, most preferably from 50 to 70 wt. % of the weight of the shoe sole.

Preferably, the rubber matrix material comprises at least 10 wt. % of a butadiene rubber based on the total weight of the rubber matrix material, preferably at least 15 wt. %, more preferably at least 20 wt. %, more preferably at least 25 wt. %, more preferably at least 30 wt. %, more preferably at least 35 wt. %, more preferably at least 40 wt. %, more preferably at least 45 wt. %, more preferably at least 50 wt. %, more preferably at least 55 wt. %, more preferably at least 60 wt. %, more preferably at least 65 wt. %, more preferably at least 70 wt. % butadiene rubber based on the total weight of the rubber matrix material and optionally 100 wt. % of the rubber matrix material.

Preferably, the butadiene rubber comprises a styrene butadiene rubber (SBR). Preferably, the rubber matrix material comprises at least 10 wt. %, preferably at least 15 wt. %, more preferably at least 20 wt. %, more preferably at least 25 wt. %, more preferably at least 30 wt. %, more preferably at least 35 wt. %, more preferably at least 40 wt. %, more preferably at least 45 wt. %, more preferably at least 50 wt. %, more preferably at least 55 wt. %, more preferably at least 60 wt. %, more preferably at least 65 wt. %, more preferably at least 70 wt. % of styrene butadiene rubber based on the total weight of the rubber matrix material. Optionally, the rubber matrix material may consist essentially or entirely of styrene butadiene rubber.

When the butadiene rubber comprises a styrene butadiene rubber it may also comprise other types of butadiene rubber. Preferably, the butadiene rubber comprises at least 10 wt. %, preferably at least 15 wt. %, more preferably at least 20 wt. %, more preferably at least 25 wt. %, more preferably at least 30 wt. %, more preferably at least 35 wt. %, more preferably at least 40 wt. %, more preferably at least 45 wt. %, more preferably at least 50 wt. %, more preferably at least 55 wt. %, more preferably at least 60 wt. %, more preferably at least 65 wt. %, more preferably at least 70 wt. % of styrene butadiene rubber based on the total weight of the butadiene rubber.

Within the meaning of the present invention, styrene butadiene rubber refers to a copolymer of butadiene units and styrene units obtained by copolymerization of one or more butadiene(s) with one or more styrene compounds. The following, for example, are suitable as styrene compounds: styrene, ortho-, meta- or para-methylstyrene, the “vinyltoluene” commercial mixture, para-(tert-butyl) styrene, methoxystyrenes, chlorostyrenes, vinylmesitylene, divinylbenzene or vinylnaphthalene. These butadiene rubbers can have any microstructure, which depends on the polymerization conditions used, in particular on the presence or absence of a modifying and/or randomizing agent and on the amounts of modifying and/or randomizing agent employed. The butadiene rubbers can, for example, be block, random, sequential or micro sequential elastomers and can be prepared in dispersion, in solution or in emulsion.

The styrene-butadiene rubber (SBR) is preferably obtained by means of copolymerisation of styrene or butadiene in solution (S-SBR) or emulsion (E-SBR). The copolymer obtained with the process in solution (S-SBR) is particularly useful for the production of shoe soles. The process in solution for the production of S-SBR elastomers allows targeted ratios to be obtained between the two monomers (butadiene and styrene) and in particular it is possible to obtain in the butadiene phase a variable content of the 1,2-vinyl configuration. The copolymer SBR preferably has a styrene unit content between 5 and 40 wt. %, preferably between 10 and 30 wt. %. The styrene unit content may be measured using the method ASTM D5775. The butadiene phase can have 1,4-cis, 1,4-trans and 1,2-vinyl configurations. Preferably, the content of 1,2-vinyl is from 0 to 30 wt. % of the total weight of the SBR copolymer. The styrene/butadiene copolymer rubber is conventionally composed of a styrene/butadiene ratio in the range of about 10/90 to about 40/60.

The styrene butadiene rubber may also refer to styrenic block copolymers such as styrene-butadiene-styrene (SBS) or may comprise other monomers such as isoprene (a “styrene-butadiene-isoprene terpolymer”).

The above-mentioned polymers are available commercially or their preparation processes are well known to persons skilled in the art.

The rubber matrix material may also comprise one or more non-butadiene elastomers.

Preferably, the content of non-butadiene elastomer is from 0 to 30 wt. % based on the total weight of the rubber matrix material, more preferably from 0 to 20 wt. % based on the total weight of the rubber matrix material, most preferably from 0 to 10 wt. % based on the total weight of the rubber matrix material.

The choice of non-butadiene elastomer is not particularly limited.

Suitable elastomers may include, vinyl polymers (including polymers or copolymers of vinyl chloride, vinyl acetate and vinyl alcohol), polyester polymers, phenoxy polymers, epoxy polymers, acrylic polymers, polyamide polymers, polypropylenes, polyethylenes, silicones, elastomers such as natural and synthetic rubbers including styrene-butadiene copolymer, polychloroprene (neoprene), nitrile rubber, butyl rubber, polysulfide rubber, cis-1,4-polyisoprene, ethylene-propylene terpolymers (EPDM rubber), and polyurethane (polyurethane rubber). The polymer matrix material may be, for example, a copolymer of vinyl chloride, vinyl acetate and/or vinyl alcohol. Sustainably-sourced polymers—commonly called “green” polymers—may also be advantageous e.g. for environmental reasons.

The non-butadiene elastomer may be a thermoplastic material. Alternatively, the non-butadiene elastomer may be a thermosetting material.

Preferably, the non-butadiene elastomer is a thermoplastic urethane elastomer and/or ethylene vinyl acetate (EVA).

The non-butadiene elastomer may comprise a single component or may be a mixture of two or more of the components listed above.

The ratio of butadiene rubber to elastomer in the rubber matrix material may be from 100:1-3:1, or from 50:1 to 3:1, or from 10:1 to 5:1.

The rubber matrix material may comprise less than 50 wt. %, or less than 40 wt. % or less than 30 wt. % or less than 25 wt. % based on the total weight of the rubber matrix material. Preferably, the rubber matrix material comprises less than 5 wt. %, more preferably less than 2 wt. %, more preferably less than 1 wt. %, more preferably less than 0.5 wt. % of natural rubber based on the total weight of the rubber matrix material. Most preferably the rubber matrix material is substantially free of natural rubber.

### Carbon Nanoparticles

The shoe sole according to the present invention comprises carbon nanoparticles selected from graphene particles and/or carbon nanotubes (CNTs).

The loading of the carbon nanoparticles in the shoe sole may be for example 0.25 wt. % or more, 0.5 wt. % or more, 1 wt. % or more, 2 wt. % or more, 5 wt. % or more or 10 wt. % or more of the total weight of the shoe sole. The upper limit for the loading of carbon nanoparticles in the shoe sole may be, for example, 1 wt. %, 2 wt. %, 5 wt. %, 10 wt. %, 15 wt. %, 20 wt. % or 30 wt. %. Preferably, the loading is from 0.5 to 15 wt. % of the total weight of the shoe sole/composition.

Preferably, the shoe sole comprises at least 0.5 parts of carbon nanoparticles per hundred parts butadiene rubber (parts per weight, ppw), preferably from 0.5 to 25 ppw carbon nanoparticles per 100 ppw butadiene rubber, preferably from 1 to 25 ppw carbon nanoparticles per 100 ppw butadiene rubber.

Apart from reducing the overall manufacturing costs of the material, optimising the percentage of carbon nanoparticles in the rubber matrix material also optimises the amount of solvent (water) required for dispersion, as an increased amount of solvent may be detrimental to the intended material properties. In addition, too high a level of carbon nanoparticles in the mixture may also reduce the elongation properties of the material (i.e. reduction of elongation with increasing graphene percentage).

The carbon nanoparticles of the present invention are dispersed in the rubber matrix material. In this way, the carbon nanoparticles are not only provided at a surface of the rubber matrix material. The carbon nanoparticles are preferably uniformly dispersed throughout the rubber matrix material since aggregates (clumps) of material may decrease the performance of the shoe sole section. However, it is not straightforward to achieve a suitably uniform dispersion of carbon nanoparticles since such particles have a powerful tendency to agglomerate and are difficult to disperse in solvents and polymer materials. Functionalisation of the carbon nanoparticles helps to improve the dispersion of the particles in the rubber matrix material. The graphene particles (which can be referred to as “graphene-material particles”, or “graphene-based particles”) may take the form of monolayer graphene (i.e. a single layer of carbon) or multilayer graphene (i.e. particles consisting of multiple stacked graphene layers). Multilayer graphene particles may have, for example, an average (mean) of 2 to 100 graphene layers per particle. When the graphene particles have 2 to 5 graphene layers per particle, they can be referred to as “few-layer graphene”.

Advantageously, these forms of carbon nanoparticles provide an extremely high aspect ratio.

The graphene particles may take the form of plates/flakes/sheets/ribbons of multilayer graphene material, referred to herein as “graphene nanoplatelets” (the “nano” prefix indicating thinness, instead of the lateral dimensions).

The graphene nanoplatelets may have a platelet thickness of less than 100 nm and a major dimension (length or width) perpendicular to the thickness. The platelet thickness is preferably less than 70 nm, preferably less than 50 nm, preferably less than 30 nm, preferably less than 20 nm, preferably less than 10 nm, preferably less than 5 nm. The major dimension is preferably at least 10 times, more preferably at least 100 times, more preferably at least 1,000 times, more preferably at least 10,000 times the thickness. The length may be at least 1.5 times, at least 2 times, at least 3 times, at least 5 times or at least 10 times the width.

The graphene particles are preferably uniformly dispersed throughout the rubber matrix material, since aggregates (clumps) of material may decrease the performance of the sole. However, it is not straightforward to achieve a suitably uniform dispersion of graphene particles since such particles have a powerful tendency to agglomerate, and are difficult to disperse in solvents and polymer materials. Functionalisation of the graphene particles helps to improve the dispersion of the particles in the rubber matrix material.

The functionalised carbon nanoparticles may alternatively or additionally comprise carbon nanotubes.

Within the meaning of this invention carbon nanotubes (CNTs) are carbon tubes having a structure related to the structure of Buckminsterfullerene (C₆₀). Preferably, the carbon nanotubes have a diameter of from 1-50 nm, more preferably from 5-20 nm, most preferably from 5-15 nm. Preferably, the nanotubes are 1 μm or more in length, preferably 5 μm or more in length, more preferably from 8 μm or more in length, most preferably about 10 μm. The nanotubes may have an upper length of 30 μm or less, or 20 μm or less, or 15 μm or less. Thus, it is preferred that the nanotubes are endowed with a high aspect ratio, having a length/diameter (L/D) of 100 or more, preferably 10³ or more, most preferably 10⁴ or more.

The carbon nanotubes may be single-walled carbon nanotubes (SWCNTs) or multi-wall carbon nanotubes (MWCNTs). The carbon nanotubes may have been produced by any known technique for the synthesis of carbon nanotubes including arc discharge, laser ablation, chemical vapour deposition and high-pressure carbon-monoxide disproportionation. Preferably, the nanotubes are synthesised using the chemical vapour deposition method, which yields high quantities of nanotubes and has a degree of control over diameter, length and morphology.

Carbon nanotubes are typically made with catalysts according to conventional techniques known in the art. These catalysts generally contain metals such as Ni, Co and Mo. Preferably, the carbon nanotubes have levels of catalyst residue below 10 wt. %, preferably below 5 wt. %, more preferably below 3 wt. %, with respect to the total weight of carbon nanotube.

The carbon nanoparticles may consist of functionalised graphene particles and functionalised CNTs.

### Functionalised Carbon Nanoparticles

The shoe soles according to the present invention comprise carbon nanoparticles comprising functionalised carbon nanoparticles.

The functionalised carbon nanoparticles are graphene particles and/or carbon nanotubes as discussed above bearing functional groups. Such functional groups can be achieved by adding, altering or removing selected chemical groups from the materials. This helps to improve the affinity of the nanoparticles for the rubber matrix material, thus allowing a more uniform distribution of functionalised carbon nanoparticles to be achieved. Preferably, the functionalised carbon nanoparticles are surface functionalised carbon nanoparticles. Surface functionalised carbon nanoparticles are carbon nanoparticles bearing functional groups on their surface, which can be achieved by adding, altering or removing selected chemical groups from the surface of the materials.

Preferably, the amount of functionalised carbon nanoparticles is at least 10%, at least 20%, at least 30%, at least 40%, at least 50%, at least 60%, more preferably at least 70%, more preferably at least 80%, or even more preferably at least 90% of the total weight of carbon nanoparticles in the shoe sole. It is especially preferred that all of the carbon nanoparticles are functionalised nanoparticles. All percentages are based on the total weight of the carbon nanoparticles.

Without being bound by any theory it is believed that the use of functionalised carbon nanoparticles allows higher loadings of carbon nanoparticles to be incorporated into the rubber matrix material as functionalisation improves the interaction between the carbon nanoparticles and the rubber matrix material. In contrast, it is often more challenging to mix carbon nanoparticles which have not been functionalised into rubber products and to deliver sufficient dispersion, without needing to process the materials through an exhaustive, long-winded and expensive process.

In cases where the shoe sole comprises both functionalised carbon nanoparticles and nanoparticles that have not been functionalised, these materials can be the same type of carbon materials or a different type of carbon material. For example, the carbon nanoparticles may consist of functionalised graphene particles and unfunctionalised CNTs. Alternatively, the carbon nanoparticles may consist of functionalised and unfunctionalised graphene particles.

Preferably, the functionalised carbon nanoparticles are oxygen-functionalised, hydroxy-functionalised, carboxy-functionalised, carbonyl-functionalised, amine-functionalised, amide-functionalised, pyrrole-functionalised, pyridine-functionalised, nitrogen functionalised, silane functionalised, mercapto-functionalised, vinyl-functionalised or halogen-functionalised.

In particular embodiments, the functionalised carbon nanoparticles are not oxygen-functionalised, or do not include graphene oxide. The inclusion of oxygen functionalisation can affect how the rubber cures and impact performance, as a result of acidity/alkalinity considerations. In particular, oxygen functionalisation can be avoided using so-called dry chemistry methods. In contrast, wet chemistry approaches often introduce oxygen (and, commonly, sulfur) impurities. Advantageously, the inventors' preferred functionalisation method—discussed elsewhere herein—is a dry chemistry method, and specifically a plasma-based approach, as is discussed further elsewhere herein.

More preferably, the functionalised carbon nanoparticles are nitrogen functionalised, silane-functionalised, mercapto-functionalised, vinyl-functionalised or halogen-functionalised. Most preferably, the functionalised carbon nanoparticles are nitrogen functionalised. Examples of such functionalised carbon nanoparticles are carbon nanoparticles which are pyrrole-functionalised, pyridine-functionalised, amine-functionalised, or amide-functionalised, and particularly amine-functionalised.

Without being bound by any theory, it is believed that these specific types of functional group allow better interaction between the functionalised filler and the butadiene rubber matrix material. For example, amine functionalised carbon nanoparticles help to increase the cross-link density and cure rate of the butadiene rubber matrix material. Silane functionalised carbon nanoparticles are believed to be linked to increased interfacial interaction between the butadiene rubber and the carbon nanoparticles, which can lead to an increase in the compatibility of the carbon nanoparticles with the butadiene rubber matrix, leading to enhanced reinforcement and performance properties. Silanes are also able to couple with reactive sites generated through functionalisation, leading to greater levels of cross-linking.

Preferably, the functional groups are present at the surface of the functionalised carbon nanoparticles and are not present in the bulk of the material. The functional groups may be added at any part of the surface, for example on the faces and/or edges of the nanoparticles.

The functional groups present on the surface of the functionalised carbon nanoparticles may be selected from nitrogen containing functional groups such as pyrrole, pyridine, primary secondary and tertiary amines and amino, carbonyl, aldehydes, alcohols, ketones; silanes, mercapto, epoxy, vinyl, alkyl, fluoro. Preferably, the most preferred functional groups set out above are employed. In practice these functional groups may be attached directly to the surface of the functionalised carbon nanoparticles or they may be grafted to the surface of the carbon nanoparticles by tethers, e.g. polymeric tethers.

The functionalised carbon nanoparticles may incorporate at least 0.1%, or at least 1%, or at least 5%, or at least 10% elements other than carbon based on the total weight of carbon (based on elemental analysis). The functionalised carbon nanoparticles may be at least 0.1% oxygen, or at least 1% oxygen or at least 5% oxygen based on the total weight of carbon filler (based on elemental analysis) or the functionalised carbon nanoparticles may be at least 0.1% nitrogen, or at least 1% nitrogen or at least 5% nitrogen based on the total weight of carbon filler (based on elemental analysis). The maximum amount of elements other than carbon may be, for example, 20%, 30% or 40% based on the total weight of the filler (based on elemental analysis).

The surface coverage of functional groups on the functionalised carbon nanoparticles may be at least 1%, at least 1.5%, at least 2%, at least 10%, at least 15% or at least 20% (wherein monolayer coverage is considered 100% coverage). This is determined by determining the atomic weight % of the added functionality using XPS compared to the unfunctionalised material. The total surface area of the particles of the functionalised carbon nanoparticles may be calculated using the BET isotherm method (gas adsorption). Generally, for the present invention levels of functionalisation are from 1 to 20%, preferably from 1.5 to 15%, more preferably from 2 to 10% (wherein monolayer coverage is considered 100% coverage).

Any suitable type of functionalisation process can be used to achieve the desired functionalisation. However, preferably, the functionalised carbon nanoparticles are plasma-functionalised (i.e. particles which have been functionalised using a plasma-based process). Advantageously, plasma-functionalised particles can display high levels of functionalisation, and uniform functionalisation. Using a plasma-based process to functionalise the particles can also lead to a reduced level of damage to the structures of the particles, as well as reduced levels of impurities (such as oxygen and sulfur impurities), compared to wet chemistry methods. In particular, the use of plasma functionalisation helps to keep the graphene particles and carbon nanomaterials intact, which means that they retain their effectiveness in reinforcing the polymeric structure of the butadiene rubber matrix material.

Plasma functionalisation also allows bespoke functionalisation of the particles and avoids the presence of impurities. For example, the Hummers method used to generate graphene oxide can introduce metallic impurities (especially manganese from the catalyst used), as well as NOₓ impurities (various forms of nitrogen oxides, including NO, NO₂, N₂O).

Accordingly, the present invention also provides use of plasma functionalised carbon nanoparticles as described herein, in a shoe sole, particularly a shoe sole as provided by the present invention.

Preferably, the total amount of manganese impurities in the carbon nanoparticles is less than 0.1 wt. %, preferably less than 10 ppm, more preferably less than 5 ppm, most preferably less than 1 ppm based on the total weight of functionalised carbon nanoparticles.

NOₓ impurities may result from nitric acid used in wet chemical methods of functionalisation. Preferably the amount of NOₓ present in the carbon nanoparticles is less than 10 ppm, preferably less than 5 ppm, most preferably less than 1 ppm. The amount of NOₓ may be determined by XPS. Impurities such as nitric acid and NOₓ are left over from wet chemistry processes and not found in functionalised carbon nanoparticles obtained by plasma treatment.

Impurities such as NOₓ can interfere with the intended use of the functionalised carbon nanoparticles. For example, without being bound by any theory, it is believed that NOₓ can interfere with cross-linking reactions of the butadiene rubber. In addition, these impurities may leach into the environment where they can be harmful to animals and aquatic life.

Plasma functionalisation is also advantageous as it enables cost effective, rapid functionalisation and modification of graphene and CNTs. Plasma processing also allows these materials to be produced in high volumes suitable for commercial applications.

In particular, the inventors have found that when functionalised nanoparticles are prepared using agitation in low-pressure plasma, such as described in WO2010/142953 and WO2012/076853, they are readily obtained in a format enabling dispersion in plasticizers/solvents and subsequently in polymer matrices, or directly in polymer melts, at good uniformity and at levels more than adequate for the purposes set out above. This is in contrast to conventional processes for separating and functionalising particles, which are extreme and difficult to control, as well as damaging to the carbon nanoparticles themselves.

Specifically, the starting material—especially graphitic carbon bodies—is subjected to a particle treatment method for disaggregating, de-agglomerating, exfoliating, cleaning or functionalising particles, in which the particles for treatment are subject to plasma treatment and agitation in a treatment chamber. Preferably the treatment chamber is a rotating container or drum. Preferably the treatment chamber contains or comprises multiple electrically-conductive solid contact bodies or contact formations, the particles being agitated with said contact bodies or contact formations and in contact with plasma in the treatment chamber.

The particles to be treated may be carbon particles, such as particles which consist of or comprise graphite, or other nanoparticles.

Preferably the contact bodies are moveable in the treatment chamber. The treatment chamber may be a drum, preferably a rotatable drum, in which a plurality of the contact bodies are tumbled or agitated with the particles to be treated. The wall of the treatment vessel can be conductive and form a counter-electrode to an electrode that extends into an interior space of the treatment chamber.

During the treatment, desirably glow plasma forms on the surfaces of the contact bodies or contact formations.

Suitable contact bodies are metal balls or metal-coated balls. The contact bodies or contact formations may be shaped to have a diameter, and the diameter is desirably at least 1 mm and not more than 60 mm.

The pressure in the treatment vessel is usually less than 500 Pa. Desirably during the treatment, gas is fed to the treatment chamber and gas is removed from the treatment chamber through a filter. That is to say, it is fed through to maintain a chemical composition if necessary and/or to avoid build-up of contamination.

The treated material, that is, the particles or disaggregated, deagglomerated or exfoliated components thereof resulting from the treatment, may be chemically functionalised by components of the plasma-forming gas, forming e.g. carboxy, carbonyl, hydroxyl, amine, amide, silane, pyrrole, pyridine, mercapto, vinyl or halogen functionalities on their surfaces. Plasma-forming gas in the treatment chamber may be or comprise e.g. any of oxygen, water, hydrogen peroxide, alcohol, nitrogen, ammonia, amino-bearing organic compounds, halogens such as fluorine, halohydrocarbons such as CF₄, and noble gases. Preferably, the plasma-forming gas is nitrogen, ammonia, or an amino-bearing organic compound, with ammonia being particularly preferred.

In particular embodiments, the plasma treatment allows particularly high levels of control over the kind and level of functionalisation. Such treatment advantageously does not require use of additional materials, such as surfactants, which can introduce impurities. Further, control over the temperature of reaction introduces accuracy so that functionality is not lost. Typically, the plasma treatment uses temperatures of 80° C. or less, though the optimum temperature range will depend on factors including the nature of the functionality and the matrix material. In general, it is considered better to use higher power for the plasma treatment, for reduced processing time and to enable key chemistries. Furthermore, in general, it is considered that arcing should be kept to a minimum. Suitably, the technologies described in applications WO2022/058218, WO2022/058546, or WO2022/058542 can be employed (and accordingly the contents of these documents are hereby incorporated by reference in their entirety).

Any other treatment conditions disclosed in the above-mentioned WO2010/142953 and WO2012/076853 may be used, additionally or alternatively. Or, other means of functionalising and/or disaggregating carbon particles may be used for the present processes and materials, although we strongly prefer plasma-treated materials.

For the present purposes the type and degree of chemical functionalisation of the functionalised carbon nanoparticles is selected for effective compatibility at the intended loadings with the selected polymer matrix material. Routine experiments may be effective to determine this.

Preferably, the zeta potential of the carbon nanoparticles is at least 3 mV, more preferably at least 10 mV, more preferably at least 15 mV, more preferably at least 20 mV, most preferably at least 30 mV. Optionally the maximum zeta potential is 70 mV. The zeta potential may be between 3 mV and 70 mV, preferably between 10 mV and 70 mV, more preferably between 15 mV and 70 mV, more preferably between 20 mV and 70 mV, most preferably between 30 mV and 70 mV. Preferably the zeta potential is at least 3 mV and the mass of nitrogen in the carbon nanoparticles is at least 1% based on the total mass of carbon nanoparticles (based on an elemental analysis), more preferably the zeta potential is at least 10 mV and the mass of nitrogen in the carbon nanoparticles is at least 1%, more preferably the zeta potential is at least 10 mV and the mass of nitrogen in the carbon nanoparticles is at least 1.5%, more preferably the zeta potential is at least 15 mV and the mass of nitrogen in the carbon nanoparticles is at least 1%, more preferably the zeta potential is at least 10 mV and the mass of nitrogen in the carbon nanoparticles is at least 1.5%, more preferably the zeta potential is at least 15 mV and the mass of nitrogen in the carbon nanoparticles is at least 2%, more preferably the zeta potential is at least 20 mV and the mass of nitrogen in the carbon nanoparticles is at least 2%, more preferably the zeta potential is at least 20 mV and the mass of nitrogen in the carbon nanoparticles is at least 2.3%, more preferably the zeta potential is at least 30 mV and the mass of nitrogen in the carbon nanoparticles is at least 2.5% (for example, 2.5-10%), most preferably the zeta potential is at least 30 mV and the mass of nitrogen in the carbon nanoparticles is at least 3% (for example, 3 to 10%, or 5 to 10%).

The skilled person will be aware of suitable methods for measuring zeta potentials. An exemplary method involves dispersing 10 mg of functionalised graphene particles in 20 mL of pH 3 solution, adding aliquots of the dispersion in a cell which is then placed in a Malvern Zetasizer Nano-Z instrument. During the measurement, a potential difference is applied at either end of the cell and the voltage is measured and recorded. The results may then be cross-referenced against a standard.

### Additional Fillers

The shoe sole may further comprise additional fillers (in addition to the carbon nanoparticles specified above). These additional fillers may comprise from 5 to 50 wt. %, preferably from 5 to 40 wt. %, more preferably from 5 to 35 wt. % of the weight of the shoe sole. The additional fillers are generally particulate materials.

Preferably, the shoe sole comprises 5 to 90 ppw additional fillers per 100 ppw butadiene rubber, preferably from 5 to 70 ppw additional fillers per 100 ppw butadiene rubber, preferably from 5 to 60 ppw additional fillers per 100 ppw butadiene rubber.

Preferably the additional filler is a non-conductive filler, such as silica. Silica is used primarily to provide structural re-enforcement to the shoe sole and to act as an anti-caking agent during manufacture. The silica is not particularly limited. Examples of the silica include wet silica (hydrous silicate), dry silica (silicic anhydride), calcium silicate, and aluminium silicate. Among silica, wet silica is preferable. Preferable examples of the wet silica include AQ, VN3, LP, and NA manufactured by Tosoh Silica Corporation, and ULTRASIL VN3 manufactured by Degussa AG.

It is believed that there is a synergistic effect between the silica filler and the functionalised carbon nanoparticles. It is believed that this effect is a result of hydrogen bonding between the moieties/species on the carbon nanoparticles and the hydroxyl groups present on the silica, preventing re-agglomeration of the particles and maintaining an effective uniform dispersion and distribution of the fillers.

Furthermore, the positive compatibility between silica and carbon nanoparticles, coupled with the enhanced reinforcement and affinity of the specific functional groups on the carbon nanoparticles with the polymer, delivers increased interfacial interactions, through chemical (covalent and hydrogen bonding) and mechanical boundary, leading to intrinsic performance improvements,

The additional filler may comprise from 10 to 100 wt. % silica, preferably from 20 to 100 wt. % wt. % silica, preferably from 30 to 100 wt. % silica, preferably from 50 to 100 wt. % silica, preferably from 70 to 100 wt. % silica, more preferably from 80 to 100 wt. % silica based on the total weight of the additional filler, most preferably the additional filler consists of silica.

In order to couple the silica to the rubber matrix material the shoe sole may also comprise a coupling agent. The coupling agent is at least bifunctional. Preferably, the coupling agent is a silane, such as an organosilane or a bifunctional polyorganosiloxane.

Preferably, 0.1 to 5 wt. %, more preferably 0.2 to 5 wt. %, more preferably 0.5 to 5 wt. % coupling agent(s) is admixed into the shoe sole composition during manufacture wherein the weight percentages are based on the total weight of the shoe sole composition.

Additionally or alternatively, the additional filler may comprise a conductive filler, preferably a conductive carbon filler. For example, the shoe sole may comprise materials such as carbon black, acetylene black (ACB), carbon nanorods or graphitic platelets or a combination of these materials. Preferably, the additional filler comprises or consists of carbon black. Without wanting to be bound by theory, it is believed that the carbon black works synergistically with the carbon nanoparticles (graphene particles and CNTS) to improve the properties of the shoe sole, such as abrasion resistance and grip/slip resistance.

The type of carbon black is not particularly limited. For example, the carbon black may be channel black, furnace black, lamp black or thermal black. Carbon black is generally obtained by the incomplete combustion of heavy petroleum products, for example FCC tar, coal tar or ethylene cracking tar. The carbon black may have a paracrystalline or amorphous structure. The carbon black may be acidic, neutral or basic.

Carbon black is commercially available, for example as CABOT BP 2000, Degussa Printex XE-2B Mitsubishi MA-7 and Orion FW 200.

Preferably, the conductive carbon filler has a volume average mean particle size of less than 10 μm. Volume average mean particle size can be determined using any suitable method known to a skilled person in the art such as light scattering (mean size=mean hydrodynamic diameter of the particles) or laser distribution particle size. Preferably, light scattering is used. Light scattering can be measured using a light scattering analyser e.g., dynamic light scattering particle size distribution analyzer LB-550 (available from HORIBA).

The use of particles with a mean particle size of less than 10 μm, means that the particles are more easily dispersed in the butadiene rubber matrix material. Optionally, the minimum mean particle size of the conductive carbon filler is 1 μm.

Optionally, the volume average mean particle size of the conductive carbon filler is different to that of the carbon nanoparticles meaning that the size distribution of carbon particles in the shoe sole is multimodal (has multiple peaks), for example bimodal. This may be achieved by the carbon nanoparticles having a relatively smaller volume average mean particle size and the conductive carbon filler having a relatively larger volume average mean particle size. Without being bound by any theory it is believed that having two different sizes of conductive particles in the rubber matrix material leads to better properties as the smaller particles are able to fill the holes in the matrix material formed by the larger particles.

Optionally, there are a limited number of carbon particles (i.e. the carbon nanoparticles and conductive carbon filler) having a size considerably larger than the volume average mean particle size. For example the D90 value (the value wherein the portion of particles with diameters below this value is 90%, determined using dynamic light scattering) may be less than 200%, less than 180%, or less than 160% of the mean particle size. In instances where the particles have a multimodal distribution, the D90 value may be less than 200%, less than 180%, or less than 160% of the peak of the distribution occurring at the highest size value. The median particle size may be within 80% to 120% of the value of the mean particle size. Optionally, the D10 value (the value wherein the portion of particles with diameters smaller than this value is 10%; determined using dynamic light scattering) is at least 40% of the mean particle size. In instances where the particles have a multimodal distribution, the D10 value may be within 80 to 120% of the peak of the distribution occurring at the lowest size value. For example, for a mean particle size of about 6.5 μm, the median is preferably from 5.2-7.8 μm. The D10 value is at least 2.6 μm and the D₉₀ value is less than 10.4 μm.

When the additional filler comprises both a conductive carbon filler and another type of additional filler, the additional filler may comprise from 0.1 to 30 wt. % conductive carbon filler, preferably from 0.1 to 15 wt. % conductive carbon filler, more preferably from 0.1 to 10 wt. % conductive carbon filler based on the total weight of the additional filler.

### Processing Aids

The shoe sole composition may also comprise additional components, for example components used to improve the processing properties of the rubber matrix material.

Preferably, the shoe sole comprises a plasticiser.

Various plasticisers are known in the art. These materials are added during manufacture of shoe soles and other rubber products to give the rubber composition improved processing properties. Plasticisers may also act as a softener in the rubber compositions. The specific plasticiser used may also affect certain performance characteristics, such as surface adhesion and grip as well as wear and durability. Plasticisers may also function as internal lubricants, improving the blending of rubber formulations and facilitating the incorporation of fillers and other additives as well as functioning as low-cost extenders (increasing the overall bulk of the rubber matrix material).

Preferably, the plasticiser has a kinematic viscosity at 100° C. of from 10 to 100 mPa·s, preferably from 15 to 70 mPa·s, more preferably from 20 to 50 mPa·s, most preferably from 30 to 40 mPa·s.

Preferably, the shoe soles or compositions according to the present invention comprise between 1 and 100 phr plasticiser (parts per hundred plasticiser in the butadiene rubber matrix material), preferably between 2 and 100 phr, more preferably between 2 and 50 phr, more preferably between 2 and 20 phr, most preferably between 2 and 10 phr.

In certain embodiments, the plasticiser is a mineral oil. Preferably, the plasticiser is a process oil.

A process oil in which the number of carbon atoms constituting paraffin chains is 50% or more (based on the total number of carbon atoms present in the process oil) is generally referred to as a “paraffin type process oil”; a process oil in which the number of carbon atoms constituting the naphthene rings is 30 to 45% (based on the total number of carbon atoms present in the process oil) is generally referred to as a “naphthene type process oil”; and a process oil in which the number of carbon atoms constituting the aromatic rings is more than 30% (based on the total number of carbon atoms present in the process oil) is generally referred to as an “aromatic type process oil”.

In the present invention, the process oil may be a paraffinic, naphthenic or aromatic process oil. Preferably the process oil is an aromatic process oil, optionally wherein the number of carbon atoms constituting the aromatic rings is more than 75% (based on the total number of carbon atoms present in the process oil).

Examples of aromatic process oils according to the present invention include Diana Process Oil AC-12, AC460, AH-16 and AH-58 manufactured by Idemitsu Kosan Co., Ltd., Mobile Sol K, Mobile Sol 22 and Mobile Sol 130 manufactured by Exxon Mobil Co., Fukkol Aromax #3 manufactured by Fuji Kosan Co., Ltd., Kyoseki Process X50, X100 and X140 manufactured by Nikko Kyoseki Co., Ltd., Rezox No. 3 and Dutorex 729UK manufactured by Shell Chemicals Co., Ltd., Koumorex 200, 300, 500 and 700 manufactured by Nisseki Mitsubishi Co., Ltd., Esso Process Oil 110 and Esso Process Oil 120 manufactured by Exxon Mobil Co., Mitsubishi 34 Heavy Process Oil, Mitsubishi 44 Heavy Process Oil, Mitsubishi 38 Heavy Process Oil and Mitsubishi 39 Heavy Process Oil manufactured by Nisseki Mitsubishi Co., Ltd.

Examples of paraffinic process oils include Catenex S946, Catenex S841, Catenex S541, Catenex T145, Ondina 941 manufactured by Shell Deutschland Oil GmbH, Diana Process Oil NS-24, NS-100, NM-26, NM-280 and NP-24 manufactured by Idemitsu Kosan Co., Ltd., Naprex 38 manufactured by Exxon Mobil Co., Fukkol FLEX #1060N, #1150N, #1400N, #2040N and #2050N manufactured by Fuji Kosan Co., Ltd., Kyoseki Process R25, R50, R200 and R1000 manufactured by Nikko Kyoseki Co., Ltd., Shellflex 371JY, Shellflex 371N, Shellflex 451, Shellflex N-40, Shellflex 22, Shellflex 22R, Shellflex 32R, Shellflex 100R, Shellflex 100S, Shellflex 100SA, Shellflex 220RS, Shellflex 220S, Shellflex 260, Shellflex 320R and Shellflex 680 manufactured by Shell Chemicals Co., Ltd., Koumorex No. 2 Process Oil manufactured by Nisseki Mitsubishi Co., Ltd., Esso Process Oil L-2 and Esso Process Oil 765 manufactured by Exxon Mobil Co. and Mitsubishi 20 Light Process Oil manufactured by Nisseki Mitsubishi Co., Ltd.

Example of naphthenic process oils according to the present invention include Edelex 946 manufactured by Shell Deutschland Oil GmbH, Diana Process Oil PW-90, PW-380, PS-32, PS-90 and PS-430 manufactured by Idemitsu Kosan Co., Ltd., Fukkol Process P-100, P-200, P-300, P400 and P-500 manufactured by Fuji Kosan Co., Ltd., Kyoseki Process P-200, P-300, P-500, Kyoseki EPT 750, Kyoseki EPT 1000 and Kyoseki Process S90 manufactured by Nikko Kyoseki Co., Ltd., Lubrex 26, Lubrex 100 and Lubrex 460 manufactured by Shell Chemicals Co., Ltd., Esso Process Oil 815, Esso Process Oil 845 and Esso Process Oil B-1 manufactured by Exxon Mobil Co., Naprex 32 manufactured by Exxon Mobil Co. and Mitsubishi 10 Light Process Oil manufactured by Nisseki Mitsubishi Co., Ltd. (former Mitsubishi Oil Co., Ltd.)

Preferably the process oil is a naphthenic process oil.

Optionally, the plasticiser may be a plant oil, such as castor oil, soybean oil or rape seed oil.

Optionally, the plasticiser may be non-phthalate plasticizer. Preferably, the non-phthalate plasticizer is selected from the group or dioctyl terephthalate (DOTP), 1,2-Cyclohexane dicarboxylic acid diisononyl ester (DINCH) or citric acid. Preferably, the non-phthalate plasticizer is dioctyl terephthalate (DOTP).

The shoe sole may also comprise a stabiliser. Stabilisers are chemical additives which may be added to polymeric materials to inhibit or retard their degradation. These compounds include antioxidants (e.g. Pentaerythritol tetrakis(3,5-di-tert-butyl-4-hydroxyhydrocinnamate, Tris(2,4-di-tert-butylphenyl)phosphite and N-Isopropyl-N′-phenyl-1,4-phenylenediamine), light stabilizers (e.g. bisoctrizole and hindered amine light stabilizers), acid scavengers, metal deactivators, heat stabilizers, flame retardants and biocides.

The shoe sole may also comprise a lubricating agent. Preferably, the lubricating agent is polyethylene glycol. Preferably, the polyethylene glycol has a viscosity average molecular weight of from 2000 to 6000 Daltons, more preferably from 3000 to 5000 Daltons, most preferably around 4000 Daltons. Without wanting to be bound by any theory, it is believed that the presence of the lubricating agent helps during the processing of the rubber and may also help to overcome any inactivating effect of inorganic fillers added in subsequent cross-linking steps.

Preferably, the shoe sole comprises between 0.5 and 5 wt. % lubricating agent, more preferably between 1 and 3 wt. % lubricating agent, most preferably between 1 and 2 wt. % lubricating agent based on the total weight of the shoe sole. Preferably, the shoe sole comprises from 0.5 to 10 ppw lubricating agent per 100 ppw butadiene rubber, preferably from 2 to 5 ppw lubricating agent per 100 ppw butadiene rubber, preferably from 2 to 4 ppw lubricating agent per 100 ppw butadiene rubber.

Preferably, the shoe sole also comprises wax. Wax is added during the manufacturing processes to improve processing properties. Preferably, the shoe sole comprises from 0.1 to 2 wt. % wax, more preferably from 0.1 to 1 wt. % wax, more preferably from 0.5 to 1 wt. % wax based on the total weight of the shoe sole. Preferably, the shoe sole comprises from 0.2 and 4 ppw wax per 100 ppw butadiene rubber, preferably from 0.2 to 2 ppw wax per 100 ppw butadiene rubber, preferably from 1 to 2 ppw wax per 100 ppw butadiene rubber.

### Cross Linking

Preferably, the butadiene rubber according to the present invention is cross linked through use of a cross-linking agent. Preferably, the cross-linking agent is added together with suitable cross-linking activators and accelerators. The cross-linking step is generally accomplished by heating the formed shoe sole under pressure.

Vulcanisation is a cross linking process in which individual molecules of rubber are converted into a three-dimensional network of interconnected polymer chains through chemical cross linking, generally with sulphur.

Preferably, the cross-linking agent is sulphur (and the cross-linking process is a vulcanisation process). Preferably, the shoe sole comprises from 0.1 to 5 wt. % sulphur, more preferably from 0.5 to 3 wt. % sulphur, more preferably from 1 to 2 wt. % sulphur based on the total weight of the shoe sole. Preferably, the shoe sole comprises from 0.2 to 5 ppw sulphur per 100 ppw butadiene rubber, preferably from 1 to 5 ppw sulphur per 100 ppw butadiene rubber, preferably from 2 to 4 ppw sulphur per 100 ppw butadiene rubber.

Preferably, cross-linking accelerators are also added to the rubber matrix material before it is formed into the shoe sole to increase the speed of cross-linking. The type of cross-linking accelerator is not particularly limited. Preferably, thiazole type accelerators and their derivatives, thiuram type accelerators and zinc dithiocarbamates type accelerators are used. More preferably, the accelerators are selected from the group consisting of 2-mercaptobenzothiazyl disulfide (abbreviated “MBTS”), N-cyclohexyl-2-benzothiazyl sulfenamide (abbreviated “CBS”), N, N-dicyclohexyl-2-benzothiazyl sulfenamide (abbreviated “DCBS”), N-tert-butyl-2-benzothiazylsulfenamide (abbreviated “TBBS”), N-tert-butyl-2-benzothiazylsulfenimide (abbreviated “TBSI”), zinc dibenzyldithiocarbamate (in abbreviated “ZBEC”) and mixtures of these compounds. Preferably, the cross-linking accelerator is a thiazole type accelerator, such as CBS. Thiazole type accelerators, such as CBS, are particularly preferred when the cross-linking agent is sulphur.

Preferably, a cross-linking activator is also admixed into the rubber matrix material before it is formed into the shoe sole. Preferably, the cross-linking activator is zinc oxide. Zinc oxide is particularly preferred in combination with thiazole type accelerators and sulphur as the cross-linking agent.

Without wanting to be bound by any theory, it is believed that functionalised carbon nanoparticles, which are pyrrole-functionalised, pyridine-functionalised, amine-functionalised, amide-functionalised, silane-functionalised, mercapto-functionalised, vinyl-functionalised or halogen-functionalised are particularly well suited to forming highly efficiently cross-links with the butadiene rubber during the cross-linking process, particularly when sulphur is used as the cross-linking agent. This leads to carbon nanoparticles which have a high density of cross-links with the butadiene matrix material. This leads to enhanced stability of the shoe sole and improved abrasion resistance. Thus, in the most preferred embodiments the shoe sole according to the present invention comprises
functionalised carbon nanoparticles, wherein the particles are pyrrole-functionalised, pyridine-functionalised, amine-functionalised, amide-functionalised, silane-functionalised, mercapto-functionalised, vinyl-functionalised or halogen-functionalised; and
sulphur as a cross-linking agent.

Preferably, cross-linking accelerators and cross-linking activators are admixed during production of such shoe soles.

### Construction of Shoe Sole

Optionally, the shoe sole is a single layer formed from said rubber matrix material, carbon nanoparticles, and other optional ingredients specified above.

In other embodiments, the shoe sole may comprise multiple layers or sections (e.g. heel, toe) bonded together. For example, the shoe sole may comprise an upper sole, an outer sole and optionally a midsole, wherein the outer sole is the layer designed to contact the ground and the upper sole is the layer closest to the wearer's foot. The midsole may be sandwiched between the outer sole and the upper sole.

The present invention extends to such multilayer shoe soles, wherein one or more of the layers comprises a rubber matrix material and carbon nanoparticles as defined in relation to the first aspect of the invention (in which case the relative wt %/ppw amounts apply in respect of that specific layer).

In such multilayer implementations, the layer according to the present invention is preferably the outer sole.

The present invention also extends to shoe soles formed from multiple bonded sections (e.g. heel, toe etc), wherein at least one of the sections comprises a rubber matrix material and carbon nanoparticles as defined above (in which case, again, the relative amounts apply in respect of said at least one section).

### Shoe

In a further aspect, the present invention relates to a shoe comprising a sole according to the present invention.

Preferably, the shoe is a type of performance footwear, for example, a walking boot, a walking shoe, a training shoe, a climbing shoe, a trail running shoe, a boot or a horse-riding boot. The above terminology is based on normal U.K. English usage, and the skilled reader will understand that certain of the above items may be given different names in other English-speaking countries, such as the U.S.

Shoes generally consist of a shoe sole and an upper, wherein the upper forms the body of the shoe. The shoe may comprise a single sole or may comprise an outer sole and an additional midsole and or insole. In cases where the shoe sole comprises an outer sole and an additional midsole or insole, generally the outer sole is according to the present invention.

The shoe sole may be attached to the upper by stitching or by the use of an adhesive glue. Preferably, the sole is attached to the upper using an adhesive glue.

The material construction of the upper is not particularly limited. However, for functional shoes it is often preferable to use breathable polyester or nylon meshes. Often the shoes are reinforced with polyurethane at the seams.

### Composition

Butadiene rubber compositions according to the present invention are also useful in applications other than shoe soles, for example hoses, seals, diaphragms and anti-vibration products, where the anti-abrasion properties of these materials are important.

Therefore, in a separate further aspect, the present invention relates to a composition comprising
a butadiene rubber matrix material;
carbon nanoparticles comprising functionalised carbon nanoparticles,
wherein, the carbon nanoparticles consist of graphene particles and/or carbon nanotubes, and
a plasticiser.

The composition comprises a butadiene rubber matrix material and carbon nanoparticles as described above for the shoe sole. The plasticisers are also as described above.

The composition may also comprise any of the additional components or additives described above for the shoe sole.

The amounts of each component may be for the composition as described above for the shoe sole.

In a further embodiment the present invention relates to an article comprising the composition described above.

In a preferred embodiment, the articles according to the present invention do not include tyres, e.g. for motor vehicles or bikes.

In a certain such embodiment, the article is a hose. Preferably, the hose may be a water hose, an air hose, a food or beverage hose, a steam hose, a petroleum transfer hose or a chemical transfer hose. Hoses made from the composition described above can demonstrate higher resistance to wear than hoses which do not comprise functionalised carbon nanoparticles.

In a certain such embodiment, the article is a seal. This may include a sealing cap, a bonded seal (Dowty seal), a bung, a compression seal fitting, a diaphragm seal, a gasket or mechanical seal (e.g. a flange gasket, an O-ring, an O-ring boss seal, or a piston ring), a glass to metal seal, a glass-ceramic-to metal-seal, a hose coupling, a hermetic seal, a hyrostatic seal, a hydrodynamic seal, an inflatable seal, a lid, a plug, a wiper seal or a dry gas seal.

In a certain such embodiments, the article is a diaphragm. Diaphragms are used in all sections of industry. Preferably, the diaphragm is a moulded diaphragm. Applications of moulded diaphragms include pump diaphragms, pressure relief valve diaphragms and loudspeaker diaphragms.

In a certain such embodiment, the article is an anti-vibration product. Anti-vibration products are used in a variety of industries, in particular the automotive industry. These articles absorb vibration and reduce vibration transmission, this can help reduce engine vibration, noise transmission and also engine oscillation. Typical examples of anti-vibration products include rubber vibration isolators, bushing mounts or conical mounts.

### Method of Manufacture

In a further aspect, the present invention provides a method of manufacture of a composition according to the present invention or a shoe sole composition suitable for use in the production of a shoe sole according to the present invention.

The method of manufacture preferably comprises:
Step 1. providing carbon nanoparticles comprising functionalised carbon nanoparticles, wherein, the carbon nanoparticles are or comprise graphene particles and/or carbon nanotubes;
Step 2. forming a dispersion of the functionalised carbon nanoparticles, wherein either
   (i) the dispersion of step 2 is formed with a rubber, or
   (ii) the method includes Step 3. combining a rubber with the dispersion.

Preferably, the rubber comprises one or more of a natural rubber or a synthetic rubber such as butadiene rubber or styrene butadiene rubber.

In particular embodiments, it is preferred that the rubber comprises a butadiene rubber.

In some preferred embodiments, the dispersion of step 2 is formed by admixing the carbon nanoparticles with a plasticiser.

Alternatively, the dispersion may be formed by admixing the functionalised carbon nanoparticles with a “masterbatch” of one or more rubbers. The masterbatch may or may not contain butadiene rubber. The masterbatch may or may not contain other constituents from a shoe sole formulation. For example, the masterbatch may or may not contain a plasticiser. In embodiments where the masterbatch does not comprise a butadiene rubber, the composition comprising the functionalised carbon nanoparticles is subsequently dispersed in a butadiene rubber in order to prepare the shoe sole according to the present invention.

Preferably the carbon nanoparticles in step 1 are provided according to the following method:
a) providing non-functionalized carbon nanoparticles, wherein the carbon nanoparticles are or comprise graphene particles and/or carbon nanotubes;
b) plasma functionalising the non-functionalized carbon nanoparticles (e.g. in a glow-discharge plasma) to obtain functionalised carbon nanoparticles; and
c) optionally mixing the functionalised carbon nanoparticles with non-functionalized carbon nanoparticles.

Preferably, the functionalised nanoparticles in step (b) are prepared using agitation in low-pressure plasma, such as described in WO2010/142953 and WO2012/076853. The starting material may be subjected to a particle treatment method for disaggregating, de-agglomerating, exfoliating, cleaning or functionalising particles, in which the particles for treatment are subject to plasma treatment and agitation in a treatment chamber. Preferably the treatment chamber is a rotating container or drum. Preferably the treatment chamber contains or comprises multiple electrically conductive solid contact bodies or contact formations, the particles being agitated with said contact bodies or contact formations and in contact with plasma in the treatment chamber.

During the treatment, desirably glow plasma forms on the surfaces of the contact bodies or contact formations.

The pressure in the treatment vessel is usually less than 500 Pa. Desirably during the treatment gas is fed to the treatment chamber and gas is removed from the treatment chamber through a filter. That is to say, it is fed through to maintain the chemical composition if necessary and/or to avoid build-up of contamination.

The treated material, that is, the particles or disaggregated, deagglomerated or exfoliated components thereof resulting from the treatment, may be chemically functionalised by components of the plasma-forming gas, forming e.g. pyrrole, pyridine, nitrogen containing functional groups such as primary secondary and tertiary amines and amino, carbonyl, aldehydes, alcohols, ketones; silanes, mercapto, epoxy, vinyl, alkyl, fluoro functionalities on their surfaces. Plasma-forming gas in the treatment chamber may be or may comprise e.g. any of oxygen, water, hydrogen peroxide, alcohol, nitrogen, ammonia, amino-bearing organic compounds, halogens such as fluorine, halohydrocarbons such as CF₄, and noble gases.

Any other treatment conditions disclosed in the above-mentioned WO2010/142953 and WO2012/076853 may be used, additionally or alternatively.

For the present purposes the type and degree of chemical functionalisation of the functionalised carbon nanoparticles is selected for effective compatibility at the intended loadings with the selected polymer matrix material. Routine experiments may be effective to determine this.

Preferably, the functionalised carbon nanoparticles produced in step (b) have the following features:
i. a manganese level of less than 10 ppm; and/or
ii. a NOₓ level of less than 10 ppm.

Step 2 preferably involves dispersing the carbon nanoparticles from step 1 in a plasticiser. The carbon nanoparticles are dispersed in the plasticiser by mixing the carbon nanoparticles and the plasticiser together.

The loading levels of carbon nanoparticles in the plasticiser are set to maintain the viscosity of the polymer system and to make downstream processing more efficient. The use of a dispersion makes processing more efficient as it means that the carbon nanoparticles are not added as a powder meaning that they are not able to waft, spill or statically attach to surfaces, resulting in a cleaner production area, which reduces the chance of cross-contamination of these materials into subsequent batches of shoe soles.

This process may also involve deagglomerating the nanomaterials to enable a more uniform distribution of particles, delivering improved dispersion and distribution of the fillers within the rubber.

The amount of carbon nanoparticles in the dispersion may range from 1-80 wt. %, preferably from 1-75 wt. %, more preferably from 1-70 wt. % based on the total weight of the dispersion.

Preferably, the dispersion is a colloidal dispersion.

Step 3 involves combining (e.g. mixing) butadiene rubber with the dispersion from step 2. The butadiene rubber is preferably provided as a solid material, such as high consistency rubber sheeting or bales, which is then softened through shear mixing—this is often referred to as mastication.

This mixing step is preferably achieved by high shear mixing the rubber at a temperature of from about 30° C. to about 130° C., more preferably from about 100° C. to about 120° C., more preferably from about 105° C. to about 115° C. Preferably, the mixing is carried out on a two-roll mill, an internal mixer or a Banbury mixer, more preferably on an internal mixer or a Banbury mixer.

Preferably, during the mixing process the butadiene rubber material is mixed between rollers or rotors, it is believed that as a result of the high shear forces the temperature increases and the viscosity decreases, enabling the nanoparticle colloidal dispersion to be thoroughly dispersed.

The butadiene rubber material may be completely masticated or partially masticated. This can result in solid “islands” of butadiene rubber remaining in a “sea” of softened polymer when it is combined with the dispersion.

The method of manufacture may also involve combining the butadiene rubber with additional components. These additional components may include:
additional fillers,
non-butadiene elastomers,
stabilizers,
lubricating agents and/or
wax.

Preferably, the method involves combining the butadiene rubber with all of these additional components.

Additionally, or alternatively the method may also involve combining the butadiene rubber with components involved in cross-linking or vulcanisation (generally, the cross-linking step is performed once the composition is formed into the end product, for example a shoe sole). These components include:
a cross-linking agent and preferably
   a cross-linking accelerator and
   a cross-linking activator.

Preferably, the cross-linking agent is sulphur. Preferably, 0.1 to 5 wt. % sulphur, or 0.5 to 3 wt. % sulphur or 1 to 2 wt. % sulphur is admixed into the butadiene rubber, based on the total weight of the butadiene rubber.

Preferably, between 0.1 and 5 wt. % of cross-linking accelerator is admixed into the butadiene rubber, more preferably between 0.5 to 3 wt. %, more preferably between 1 to 2 wt. % based on the total weight of the butadiene rubber.

Preferably, between 1 to 2 wt. % of cross-linking activator is admixed into the butadiene rubber, more preferably from 0.1 to 1.5 wt. %, more preferably from 0.5 to 1.5 wt. % based on the total weight of the butadiene rubber.

The additional components and the components involved in cross-linking or vulcanisation can be added at any point during the manufacturing method, for example they may be added directly into the masticated butadiene rubber or they may be added into the plasticiser dispersion and then subsequently combined with the butadiene rubber.

The mixing in step 3 may be performed using any type of mixer known in the art, such as a shear mixer, an internal mixer or a Banbury mixer.

It is important that the temperature of the rubber matrix material is maintained during this mixing step to prevent the rubber from solidifying. Preferably the mixture is mixed for a time period of from 10 to 30 minutes, preferably for about 10 to 20 minutes, more preferably for about 12 minutes. Without being bound by any theory, it is believed that if the shoe sole mixture stays too hot for too long, it gets too “sticky” and is difficult to handle.

The method of manufacture may also involve step 4, wherein the shoe sole composition from step 3 is formed into pellets or a masterbatch.

In a further aspect, the present invention relates to a method of manufacture of a shoe sole, the method comprising
producing a shoe sole composition according to the method described above; and
moulding the shoe sole composition into a shoe sole.

Preferably, the method of manufacture of a shoe sole involves shaping the shoe sole composition in a mould and removing the shaped sole from the mould. Preferably, this involves injection moulding, pour moulding or compression moulding of the shoe sole mixture into a mould to form the shoe sole, more preferably direct injection moulding, injection moulding to form a preform followed by compression moulding the preform into a final shape, compression moulding to form a preform from a bulk polymer and then compression moulding the preform into a final shape or direct compression moulding of the sole mixture to form the shoe sole. Most preferably, the method involves direct injection moulding of the sole mixture into a mould to form the shoe sole.

The shoe sole composition may be provided as a mixed composition (for example a mixed composition directly after manufacture of the shoe sole composition). Alternatively, the shoe sole composition may be provided as bales, sheeting, or pellets (often referred to as a masterbatch), which may be subsequently remixed and moulded into the shoe sole.

Preferably, the method of manufacture of a shoe sole involves a further step of curing the shoe sole to obtain a cross-linked shoe sole. In this case, the method of manufacture of the shoe sole composition generally involves combining the butadiene rubber with additional components involved in cross-linking including a cross-linking agent and preferably a cross-linking accelerator and a cross-linking activator.

Cross-linking may be achieved by heating (curing) the shoe sole in a mould. The shoe sole may be heated at between 10° and 190° C., preferably between 15° and 170° C., more preferable around 160° C. during the cross-linking step. The pressure used may be at least 0.5 megapascal, more preferably at least 1 megapascal and optionally up to a maximum pressure of 5 megapascals. The cross-linking step may be carried out for a period of from 2 minutes to 1 hour, preferably for 2 minutes to 20 minutes, more preferably from 5 minutes to 18 minutes.

The cross-linking step may also be achieved by heating the shoe soles in an autoclave, using microwave irradiation or using a fluidized bed system.

In a further embodiment, the present invention relates to a method of producing a shoe, which involves producing a shoe sole according to the method defined above and then attaching the shoe sole to an upper in order to produce a shoe.

### PREFERRED EMBODIMENTS

Particularly preferred embodiments include:

A shoe sole comprising
styrene butadiene rubber;
functionalised graphene particles
plasticiser;
stabiliser; and
silica.

Preferably, the shoe sole comprises:
40 to 80 wt. % styrene butadiene rubber;
0.5 to 15 wt. % functionalised graphene particles;
0.5 to 10 wt. % plasticiser; and
10 to 40 wt. % silica,
   wherein the weight percentages are based on the total weight of the shoe sole.

Preferably, the shoe sole further comprises 0.5 to 5 wt. % of a lubricating agent, based on the total weight of the shoe sole.

Preferably, the functionalised graphene particles are pyrrole-functionalised, pyridine-functionalised, amine-functionalised, amide-functionalised, silane-functionalised, mercapto-functionalised, vinyl-functionalised or halogen-functionalised and the shoe sole comprises sulphur as the cross-linking agent. Preferably, the shoe sole comprises from 0.1 to 5 wt. % sulphur, or from 0.5 to 3 wt. % sulphur, or from 1 to 2 wt. % sulphur based on the total weight of the shoe sole.

In a further particularly preferred embodiment, the present invention relates to a method of manufacture of a shoe sole according to the present invention, comprising
Step 1. providing carbon nanoparticles comprising functionalised carbon nanoparticles, wherein, the carbon nanoparticles are or comprise graphene particles and/or carbon nanotubes;
Step 2. admixing the functionalised carbon nanoparticles with a plasticiser to form a dispersion;
Step 3. combining butadiene rubber with the dispersion to form a shoe sole composition;
Step 4. moulding the shoe sole composition into a shoe sole; and
Step 5. curing the shoe sole to obtain a cross-linked shoe sole,
   wherein the method further comprises combining the butadiene rubber with components involved in cross-linking including a cross-linking agent, a cross-linking accelerator and a cross-linking activator.

Preferably, the cross-linking agent is sulphur.

Preferably, the carbon nanoparticles provided in step 1 are plasma functionalised carbon nanoparticles provided according to the following method, wherein the method comprises the steps of
a) providing unfunctionalized carbon nanoparticles, wherein the carbon nanoparticles are or comprise graphene particles and/or carbon nanotubes;
b) plasma functionalising the unfunctionalized carbon nanoparticles (e.g. in a glow-discharge plasma) to obtain functionalised carbon nanoparticles; and
c) optionally providing additional unfunctionalized carbon nanoparticles.

Preferably, the carbon nanoparticles provided in step 1 have pyrrole, pyridine, nitrogen containing functional groups such as primary secondary and tertiary amines and amino, carbonyl, aldehydes, alcohols, ketones; silanes, mercapto, epoxy, vinyl, alkyl, fluoro functionalities on their surfaces, particularly preferably nitrogen containing groups, most preferably a nitrogen-containing group as discussed elsewhere herein.

### EXAMPLES

### Example 1

TABLE 1
Properties of the shoe soles

| Property | Measurement method | |
|---|---|---|
| Tear strength at break | ISO22654 | >27% |
| Elongation at break | ISO22654 | >30% |
| Tear strength | EN ISO20874/ | X Direction <53%, |
| | ISO20872 | Y Direction >24% |
| Abrasion resistance | ISO20871 | <12% |
| Slip resistance, water | EN ISO13287 | flat >50%, |
| | | heel >53% |
| Slip resistance, detergent | EN ISO13287 | flat >15%, |
| | | heel >6% |
| Abrasion resistance | ISO20871 | <12% |
| Electrical conductivity | | <10⁶ Ω or <10⁹ |
| for anti-static dissipation | | |
| (at minimal filler loading) | | |
| Hardness range | | 30-80 shore A |

### Example 2

Nitrogen-functionalised carbon nanoparticles were prepared. The nitrogen-functionalised carbon nanoparticles were prepared by plasma-treating carbon nanoparticles with either ammonia (NH₃) or nitrogen (N₂). The mass % of N functionalisation was measured by XPS.

Oxygen-functionalised carbon nanoparticles were also prepared. The oxygen-functionalised carbon nanoparticles were also prepared by plasma treatment.

These nitrogen-functionalised carbon nanoparticles were dispersed in a composition including butadiene rubber and tested for ozone resistance and abrasion resistance.

Ozone resistance was measured by exposing the compositions to ozone and visually inspecting for cracks. Where cracks are observed, the composition was labelled “F” and where no cracks were observed, the composition was labelled “P”.

Abrasion resistance was measured using a standard sandpaper method.

Some preliminary results are shown in the table below. Compositions A to C contained ammonia-treated carbon nanoparticles, and D to F contained nitrogen-treated carbon nanoparticles.

| Composition | A | B | C | D | E | F |
|---|---|---|---|---|---|---|
| N (mass %) | 0.86 | 2.41 | 3.03 | 3.47 | 5.08 | 5.21 |
| zeta potential | 1.67 | 30.7 | 38.8 | 14.9 | 23.85 | 20.95 |
| Ozone Resistance | F | P | P | F | F | P |

Oxygen-treated carbon nanoparticles performed very poorly in ozone resistance. Thus, the results suggest that nitrogen-functionalised carbon nanoparticles can give good ozone resistance compared to carbon nanoparticles functionalised with other functional groups such as oxygen.

In addition, the results suggest that ozone resistance may be better for compositions having ammonia-treated carbon nanoparticles than nitrogen-treated carbon nanoparticles. It is possible that the extent of functionalisation or zeta potential may be relevant to ozone resistance.

In addition, abrasion resistance was observed to generally increase with zeta potential and/or nitrogen concentration for ammonia-treated carbon nanoparticles, with a maximum observed at a functionalisation level of around 3-3.2 mass % N.

1. A shoe sole comprising:
a rubber matrix material comprising a butadiene rubber; and
carbon nanoparticles comprising functionalised carbon nanoparticles,
wherein, the carbon nanoparticles comprise graphene particles and/or carbon nanotubes.

2. The shoe sole of claim 1, wherein the carbon nanoparticles consist of graphene particles and/or carbon nanotubes.

3. The shoe sole according to claim 1 or 2, wherein the carbon nanoparticles are dispersed in the butadiene rubber.

4. The shoe sole according to any one of the preceding claims, wherein the rubber matrix material comprises from 20 to 99.5 wt. %, preferably from 30 to 99.5 wt. %, more preferably from 30 to 80 wt. %, more preferably from 40 to 80 wt. %, more preferably from 50 to 80 wt. %, more preferably from 50 to 70 wt. % of the total weight of the shoe sole.

5. The shoe sole according any one of the preceding claims, wherein the rubber matrix material is at least 30 wt. %, preferably at least 35 wt. %, more preferably at least 40 wt. %, more preferably at least 45 wt. %, more preferably at least 50 wt. %, more preferably at least 55 wt. %, more preferably at least 60 wt. %, more preferably at least 65 wt. %, more preferably at least 70 wt. % butadiene rubber based on the total weight of the rubber matrix material.

6. The shoe sole according to any one of the preceding claims, wherein the butadiene rubber comprises or consists of styrene butadiene rubber.

7. The shoe sole according to any one of the preceding claims, wherein the rubber matrix material has a density of from 50 to 120 kg m⁻³, more preferably from 60 to 110 kg m⁻³, more preferably from 70 to 100 kg m⁻³, more preferably from 85 to 100 kg m⁻³.

8. The shoe sole according to any one of the preceding claims, wherein the shoe sole comprises less than 5 wt. %, or less than 2 wt. %, or less than 1 wt. %, or less than 0.5 wt. % of natural rubber, or wherein the shoe sole is substantially free of natural rubber.

9. The shoe sole according to any one of the preceding claims comprising 0.5 to 15 wt. % of the carbon nanoparticles based on the total weight of the shoe sole.

10. The shoe sole according to any one of the preceding claims, wherein the functionalised carbon nanoparticles are carbon nanoparticles that are one or more of: oxygen-functionalised, hydroxy-functionalised, carboxy-functionalised, carbonyl-functionalised, amine-functionalised, amide-functionalised, pyrrole-functionalised, pyridine-functionalised, nitrogen functionalised, silane functionalised, mercapto-functionalised, vinyl-functionalised or halogen-functionalised and preferably wherein the shoe sole further comprises sulphur as a cross-linking agent.

11. The shoe sole according to any one of the preceding claims, wherein the functionalised carbon nanoparticles have nitrogen-containing, such as pyrrole, pyridine, amine, or amino, or carbonyl, aldehyde, alcohol, ketone; silane, mercapto, epoxy, vinyl, alkyl or fluoro functional groups on their surfaces and preferably wherein the shoe sole further comprises sulphur as a cross-linking agent.

12. The shoe sole according to any one of the preceding claims, wherein the carbon nanoparticles are not graphene oxide, or are not oxygen-functionalised.

13. The shoe sole according to any one of the preceding claims further comprising an additional filler and optionally, wherein the additional filler is silica.

14. The shoe sole according to claim 13, wherein the additional filler is present at a concentration of from 5 to 40 wt. %, preferably from 5 to 35 wt. % based on the total weight of the shoe sole.

15. The shoe sole according to any one of the preceding claims, wherein the rubber matrix material further comprises a non-butadiene elastomer, preferably wherein the non-butadiene elastomer is a thermoplastic urethane elastomer and/or ethylene vinyl acetate.

16. The shoe sole according to any one of the preceding claims, further comprising a plasticiser, preferably wherein the plasticiser is a mineral oil.

17. The shoe sole according to any one of the preceding claims, further comprising a lubricating agent, preferably wherein the lubricating agent is polyethylene glycol.

18. The shoe sole according to any one of the preceding claims, comprising:
40 to 80 wt. % styrene butadiene rubber;
0.5 to 15 wt. % functionalised graphene particles;
0.5 to 10 wt. % plasticiser;
10 to 40 wt. % silica.

19. A method of manufacturing a composition suitable for use in the production of a shoe sole according to any one of the preceding claims comprising
Step 1. providing carbon nanoparticles comprising functionalised carbon nanoparticles, wherein the carbon nanoparticles are or comprise graphene particles and/or carbon nanotubes;
Step 2. forming a dispersion of the functionalised carbon nanoparticles, wherein either
(i) the dispersion of step 2 is formed with a rubber, or
(ii) the method includes Step 3. combining a rubber with the dispersion.

20. The method of manufacturing a composition according to claim 19, wherein the dispersion of step 2 is formed by admixing the carbon nanoparticles with a plasticiser and/or
optionally wherein the rubber comprises one or more of a natural rubber or a synthetic rubber such as butadiene rubber or styrene butadiene rubber, preferably wherein the rubber is a butadiene rubber.

21. The method of manufacturing a composition according to claim 20, wherein the nanoparticles in step 1 are provided according to the following method,
a) providing non-functionalized carbon nanoparticles, wherein the carbon nanoparticles are or comprise graphene particles and/or carbon nanotubes;
b) plasma functionalising the non-functionalized carbon nanoparticles to obtain functionalised carbon nanoparticles; and
c) optionally mixing the functionalised carbon nanoparticles with non-functionalized carbon nanoparticles.

22. Use of plasma functionalised carbon nanotubes in a shoe sole according to any one of claims 1 to 18 or in a method according to claims 19 to 21.

23. A method of manufacturing a shoe sole according to any one of claims 1 to 18, the method comprising
producing a shoe sole composition according to any one of claims 19 to 21; and
moulding the shoe sole composition into a shoe sole.

24. The method of manufacturing a shoe sole according to claim 23, wherein the method further comprises the step of curing the shoe sole to obtain a cross-linked shoe sole, wherein the shoe sole composition further comprises at least one of a cross-linking agent, a cross-linking accelerator and a cross-linking activator.

25. A shoe comprising the shoe sole according to any one of claims 1 to 18.

26. A composition comprising
a butadiene rubber;
carbon nanoparticles comprising functionalised carbon nanoparticles; and
a plasticiser,
wherein, the carbon nanoparticles are graphene particles and/or carbon nanotubes.

27. The composition according to claim 26, wherein the functionalised carbon nanoparticles are oxygen-functionalised, hydroxy-functionalised, carboxy-functionalised, carbonyl-functionalised, amine-functionalised, amide-functionalised, pyrrole-functionalised, pyridine-functionalised, nitrogen functionalised, silane functionalised, mercapto-functionalised, vinyl-functionalised or halogen-functionalised and preferably wherein the composition further comprises sulphur as a cross-linking agent.

28. An article formed from the composition according to claim 26 or 27, preferably wherein the article is a hose, a seal, a diaphragm or an anti-vibration product.
